(19) United States
(12) Patent Application Publication
(10) Pub. No.: US 2020/0150848 A1
(43) Pub. Date: May 14, 2020

(54) REAL TIME SURVEILLING OF AGRICULTURAL MACHINES

(71) Applicant: CNH Industrial America LLC, New Holland, PA (US)

(72) Inventor: Yong Deng, Peoria, IL (US)

(73) Assignee: CNH Industrial America LLC

(21) Appl. No.: 16/190,660

(22) Filed: Nov. 14, 2018

(51) Int. Cl. G06F 3/0481; A01B 63/02; H04N 13/204; G06T 15/20

(52) U.S. Cl. CPC G06F 3/04815; G06T 15/205; H04N 13/204; A01B 63/02

(57) ABSTRACT

In one aspect, a system for surveilling agricultural machines can include an agricultural machine including a work vehicle having a cabin and being coupled to an agricultural implement. The system can also include an imaging system proximate the work vehicle. The imaging system can include at least two imaging devices configured to generate a plurality of images of the agricultural implement from at least two perspectives. The system can also include one or more processors configured to process the plurality of images to create a virtualized 3D view of the agricultural implement, and a display system within the cabin. The display system can be configured to display the virtualized 3D view of the agricultural implement.

### FIELD OF THE INVENTION

The present subject matter relates generally to systems and methods for real time imaging and surveilling of agricultural machines and, more particularly, to a system and method for producing virtualized views external to a cabin of a work vehicle to aid in ascertaining performance of an agricultural implement.

### BACKGROUND OF THE INVENTION

Currently, operators of work vehicles, such as tractors and other agricultural vehicles, have a field of view from a cabin of the work vehicle that is relatively fixed. Namely, the operator can adjust his seating position or move his head to obtain a slightly different perspective, but generally the field of view has a maximum based on the size and shape of windows and view ports on the machine. In many instances, an operator may desire an alternate view of external equipment of performance of the work vehicle. In these instances, the operator typically must cease work, exit the cabin, and physically move about the agricultural machine.

Accordingly, a system and method for increasing visibility to aid in ascertaining performance while limiting the need for an operator to exit a cabin of a work vehicle would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a system for surveilling an agricultural machine. The system can include the agricultural machine. The agricultural machine can include a work vehicle having a cabin and being coupled to an agricultural implement. The system can also include an imaging system proximate the work vehicle. The imaging system can include at least two imaging devices configured to generate a plurality of images of the agricultural implement from at least two perspectives. The system can also include one or more processors configured to process the plurality of images to create a virtualized 3D view of the agricultural implement, and a display system within the cabin. The display system can be configured to display the virtualized 3D view of the agricultural implement.

In another aspect, the present subject matter is directed to a method of surveilling agricultural machines. The method can include generating a plurality of images of an agricultural implement coupled to a work vehicle. The plurality of images can be taken from at least two perspectives of the agricultural implement. The method can also include processing the plurality of images to create a virtualized 3D view of the agricultural implement. Furthermore, the method can include displaying the virtualized 3D view on a display within a cabin of the work vehicle.

According to another aspect, the present subject matter is directed to an apparatus for surveilling agricultural machines. The apparatus can include an imaging system configured to be arranged proximate a work vehicle. The imaging system can include at least two imaging devices configured to generate a plurality of images of an agricultural implement coupled to the work vehicle from at least two perspectives. The apparatus can further include one or more processors configured to process the plurality of images to create a virtualized 3D view of the agricultural implement. The apparatus can also include a display system configured to be mounted within the cabin, the display system configured to display the virtualized 3D view of the agricultural implement.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a side view of one embodiment of an agricultural machine in accordance with aspects of the present subject matter;

FIG. 2 illustrates an overhead view of one embodiment of the agricultural machine shown in FIG. 1 in accordance with aspects of the present subject matter, particularly illustrating an imaging system configured to generate a plurality of images from at least two perspectives;

FIG. 3A illustrates an example imaging layout for surveilling an example object from at least two perspectives;

FIG. 3B illustrates an example virtualized 3D view of the example object of FIG. 3A;

FIG. 4A illustrates an example imaging layout for surveilling an agricultural implement coupled to work vehicle from at least two perspectives;

FIG. 4B illustrates an example virtualized 3D view of the agricultural implement of FIG. 4A;

FIG. 5 illustrates an example view of one embodiment of a graphical user interface of an agricultural machine in accordance with aspects of the present subject matter;

FIG. 6 illustrates a flowchart of one embodiment of a method of surveilling agricultural machines, such as the agricultural machine of FIG. 1 and FIG. 2, in accordance with aspects of the present subject matter; and

FIG. 7 illustrates a block diagram of an example computing system that can be used to implement methods in accordance with aspects of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems, apparatuses, and methods for surveilling agricultural machines. For example, a system can include an agricultural machine. The agricultural machine can include a work vehicle having a cabin and being coupled to an agricultural implement. The particular work vehicle and agricultural implement are variable, but, in one embodiment, can include at least a work vehicle being operated by an operator, and an agricultural implement being coupled to and towed behind the work vehicle. In this manner, the operator may not have a forward view of the agricultural implement from the cabin during normal operation of the work vehicle.

The system can also include an imaging system proximate the work vehicle. The imaging system can include at least two imaging devices configured to generate a plurality of images of the agricultural implement from at least two perspectives. The imaging devices can be cameras mounted rearward of the cabin such that the at least two perspectives include overlapping fields of view. Accordingly, the overlapping fields of view may provide a larger viewing angle as compared to a single imaging device when considered together. This larger viewing angle may be virtualized or rendered in a virtual 3D view, such as an axonometric projection. The rendered axonometric projection can include any appropriate projection, including an isometric projection or a projection from other viewing angles of the agricultural implement.

The system can also include one or more processors configured to process the plurality of images to create the virtualized 3D view of the agricultural implement, and a display system within the cabin. The processors may process the images based on preconfigured algorithms configured to generate axonometric views, wireframe plots, or other views automatically. The display system can be configured to display the virtualized 3D view of the agricultural implement. Generally, the display system can include a display, such as a touchscreen display, allowing some interaction with the display and/or the virtualized 3D view.

In one embodiment, a computer-implemented graphical user interface may be provided to allow interaction with the virtualized 3D view. For example, at least partial rotation, change of perspective, and/or increase/decrease of the zoom level associated with the virtualized 3D view may be possible.

In another embodiment, an apparatus for surveilling an agricultural machine may also be provided. The apparatus may include the imaging system and display system described above, and may be configured to be installed on a work vehicle. In this manner, work vehicles and agricultural machines of many forms may be altered to include the features described herein.

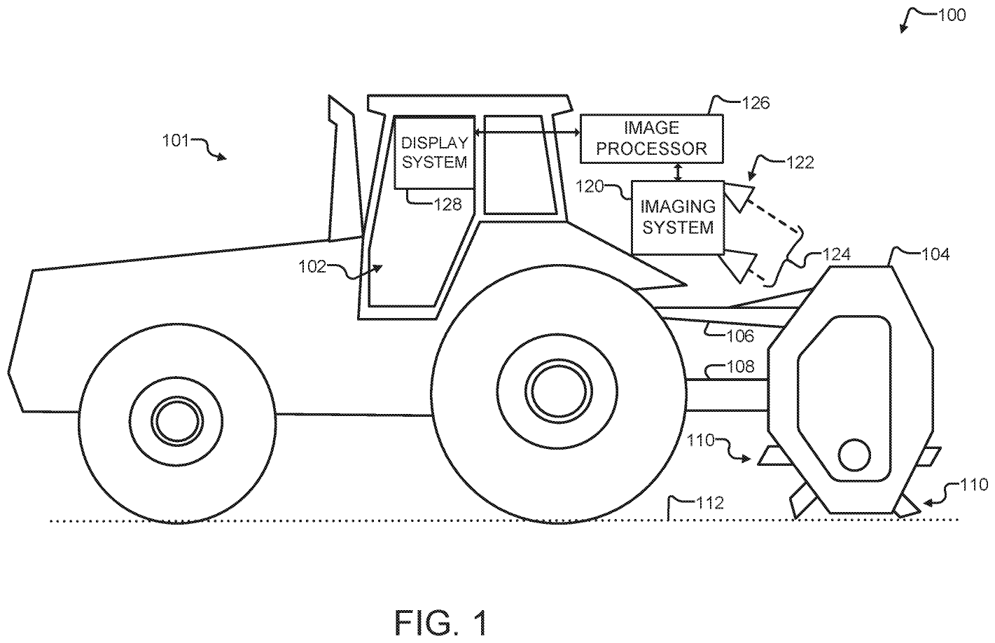

Referring now to the drawings, FIG. 1 illustrates a side view of one embodiment of an agricultural machine 100. In general, the machine 100 comprises a work vehicle 101 (e.g., a tractor) having a cabin 102, and an agricultural implement 104 configured to be towed behind the work vehicle 101.

As shown in FIG. 1, the implement 104 may include a tow bar assembly 106, which is shown in the form of an A-frame hitch assembly. The tow bar assembly 106 may include a hitch configured to attach to an appropriate tractor hitch via a ball, clevis, or other coupling. Additionally, the implement 104 may include a powered shaft or power coupling 108 configured to be coupled to a power output of the work vehicle 101. The implement 104 may also include at least one sensor (not illustrated) configured to sense at least one performance metric (such as depth or downward force) of the agricultural implement 104.

In the particular arrangement illustrated in FIG. 1, the implement 104 is a powered tiller having rotating splines 110 configured to engage and disrupt/till a surface 112. It should be appreciated that many forms of agricultural implements may be towed behind a work vehicle, such as the vehicle 101. Accordingly, while the above and following description is made in reference to the implement 104, it should be understood that any suitable work vehicle 101 and implement 104 can be applicable to example embodiments of the present subject matter, and are considered to be within the scope of this disclosure. For instance, suitable implements may include, but are not limited to, tillage implements, planting implements (e.g., seeders and/or planters), balers, sprayers, and/or the like.

As further shown in FIG. 1, the implement 104 is coupled rearward from the cabin 102. In this manner, an operator seated within the cabin may not have a forward view of the implement 104 from within the cabin 102 during normal operation of the work vehicle 101. However, the system 100 can be configured to surveil the implement 104 as described below, to provide the operator a virtualized 3D view of the implement 104 during operation of the work vehicle 101.

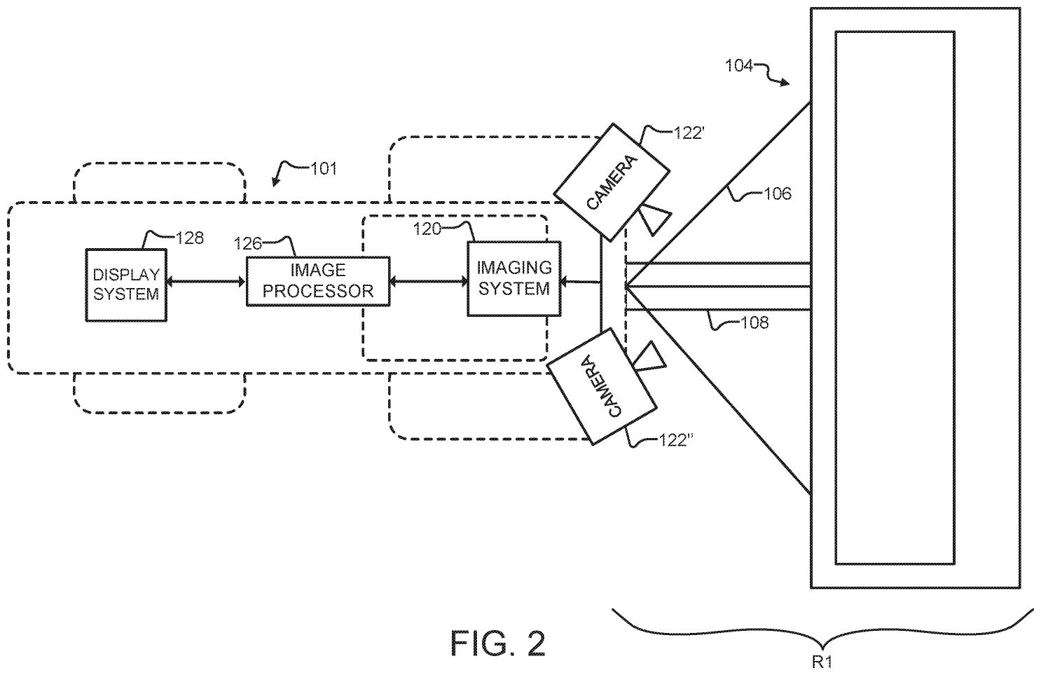

With reference to both FIG. 1 and FIG. 2, the system 100 includes an imaging system 120 proximate the work vehicle 101. The imaging system 120 can include at least two imaging devices 122 configured to generate a plurality of images of the agricultural implement 104. The plurality of images may be generated from at least two perspectives. It is noted that additional imaging devices, including other perspectives and views, are also possible.

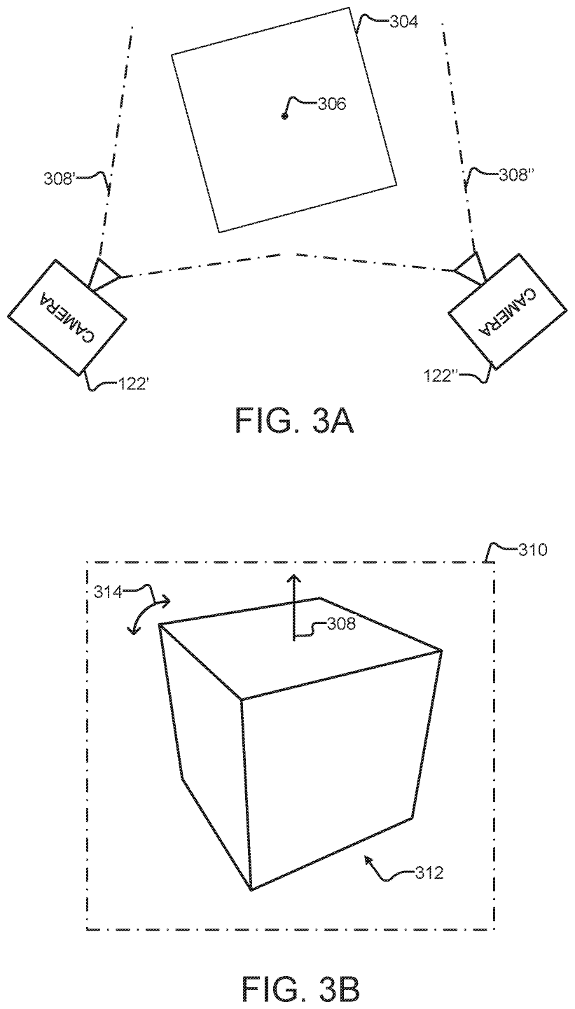

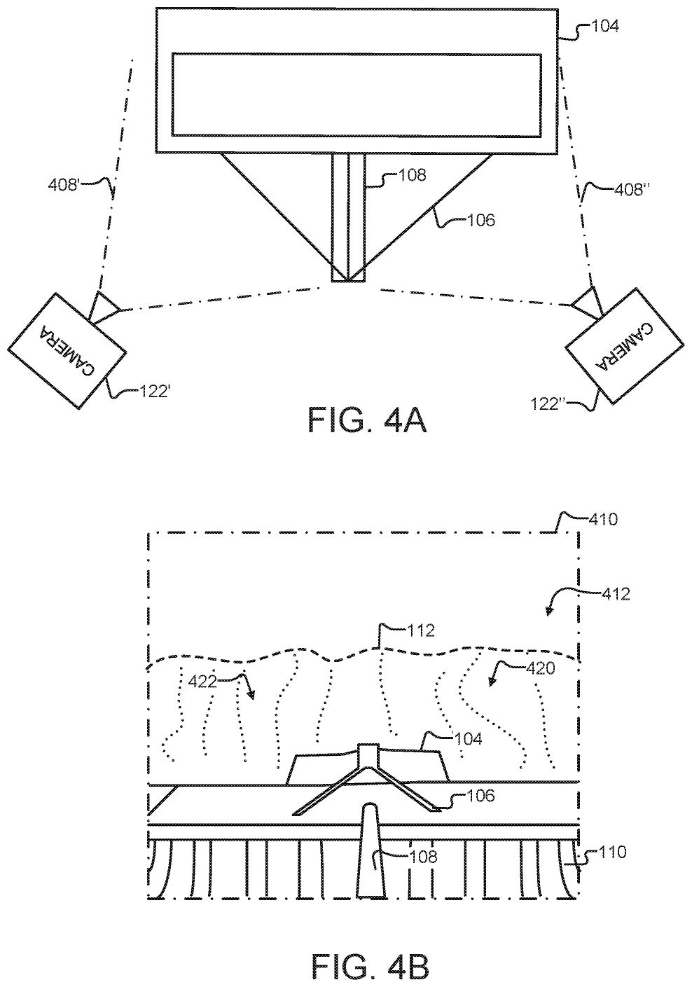

The imaging devices 122 can be cameras mounted rearward R1 of the cabin 102 such that the at least two perspectives include overlapping fields of view 124. The overlapping fields of view may provide a larger viewing angle as compared to a single imaging device when considered together, which is described more fully with reference to FIGS. 3A and 4A, below. This larger viewing angle may be virtualized or rendered in a virtual 3D view, such as an axonometric projection. The rendered axonometric projection can include any appropriate projection, including an isometric projection or a projection from other viewing angles of the agricultural implement.

The system can also include an image processor 126 configured to process the plurality of images to create the virtualized 3D view of the agricultural implement, and a display system 128 within the cabin. The image processor 126 may include one or more processors or other units configured to perform various methods and operations. The image processor 126 or processors may process the images based on preconfigured algorithms configured to generate axonometric views, wireframe plots, or other views automatically. The display system 128 can be configured to display the virtualized 3D view of the agricultural implement 104 for view by an operator within the cabin 102. Generally, the display system 128 can include a display, such as a touchscreen display, allowing some interaction with the display and/or virtualized 3D view by the operator. The display system 128 may also include a standalone display, a heads-up display, a display projected on windows of a cabin of the work vehicle, a flexible/foldable touchable layer overlaid on windows of a cabin of the work vehicle, or any other suitable display system.

As described above, a system for surveilling an agricultural machine may include an imaging system arranged to generate a plurality of images of an agricultural implement from at least two perspectives. The two perspectives may include at least a partially overlapping field of view such that a virtualized 3D view of the implement may be generated by an imaging processor or processors 126. Hereinafter, virtualized 3D views are discussed in detail with reference to FIGS. 3A, 3B, 4A, and 4B.

FIG. 3A illustrates an example imaging layout for surveilling an example object 304, such as the agricultural implement 104. As shown, a first imaging device 122′ and a second imaging device 122″ are arranged to have at least partially overlapping fields of view 308′ and 308″, respectively. Accordingly, an entire field of view provided by the imaging system encompasses a larger field of view than either individual camera. In this regard, images provided by both imaging devices can be used to surveil the object 304 from various angles about a central axis 306.

Through image processing, an axonometric view can be generated having a portion of the field of view 308′ and 308″ projected upon a two dimensional viewing surface, such as a display. For example, FIG. 3B illustrates an example virtualized 3D view 312 of the example object 304. The view 312 is projected on a two dimensional surface or plane 310. Thus, when viewed on a display, such as the display system 128, only a portion of the entire field of view 308′ and 308″ is provided. However, this virtualized 3D view 312 may be at least partially rotated about the central axis 306 as shown with arrows 314.

Accordingly, instead of having a ‘fish-eye’ or distorted view of the object 304, a relatively undistorted view 312 can be provided that can be at least partially manipulated to aid in operating the object 304 or an implement being surveilled. For example, FIGS. 4A and 4B illustrate virtualized 3D view generation of images of the agricultural implement 104.

FIG. 4A illustrates an example imaging layout for surveilling the agricultural implement 104 and FIG. 4B illustrates an example virtualized 3D view 412 of the agricultural implement 104. As shown, a first imaging device 122′ and a second imaging device 122″ are arranged to have at least partially overlapping fields of view 408′ and 408″, respectively. Accordingly, an entire field of view provided by the imaging system encompasses a larger field of view than either individual camera. In this regard, images provided by both imaging devices can be used to surveil the implement 104 from various angles about a central axis (e.g., as defined by the power coupling 108).

Through the image processing described above, an axonometric view can be generated having a portion of the field of view 408′ and 408″ projected upon a two dimensional viewing surface 410. Thus, when viewed on a display, such as the display system 128, only a portion of the entire field of view 408′ and 408″ is provided. However, this virtualized 3D view 412 may be at least partially rotated about the power coupling 108. This provides an operator with views of the implement 104, the hitch assembly 106, the surface 112, and the worked surface features 420 and 422.

Accordingly, instead of having a ‘fish-eye’ or distorted view of the implement 104, a relatively undistorted view 412 can be provided. The view 412 can aid an operator in ascertaining the performance of the implement 104 through views of the worked surface features 420 and 422, as well as determine if there are disconnections or assembly issues in the power coupling 108 and the hitch assembly 106 during operation of the working vehicle 101.

It is further noted that the plurality of images can include a video feed of the agricultural implement 104. For example, the imaging devices 122′ and 122″ may be cameras generating video of the implement 104. Thus, the virtualized 3D view 412 can also include a virtualized 3D video of the agricultural implement during operation. It should be readily understood that similar techniques in providing static virtualized 3D views may be used to generate the virtualized 3D video.

Although particularly described as being a virtualized 3D view using images from at least two imaging devices, further virtualization may be possible. For example, the images received from the at least two imaging devices may be processed to generate a view in a format similar to a wireframe plot or computer-aided design (CAD) format.

The plane or viewing area 410 including the view 412 (or virtualized 3D video) may be displayed on a display system, such as display system 128 from within a cabin of the vehicle 101. Additionally, the virtualized 3D view may be streamed or transmitted to other devices for display, such as a smartphone, tablet, or another computing device. These displays may be provided with a graphical user interface, as described more fully below.

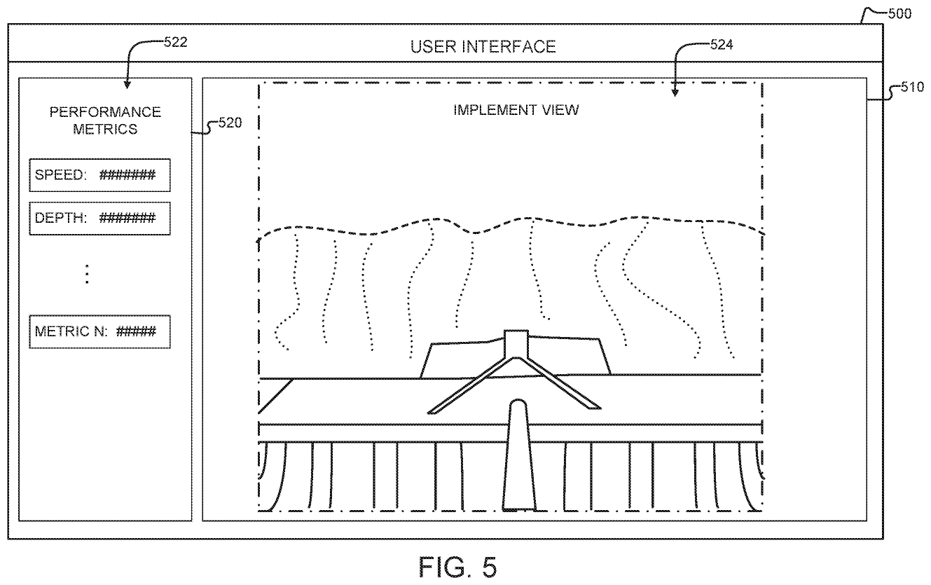

FIG. 5 illustrates an example view of one embodiment of a graphical user interface 500 of an agricultural machine in accordance with aspects of the present subject matter. As shown, the graphical user interface 500 may include a performance metrics view 522 and an agricultural implement view 524. Both views may be rendered on a display device in view of an operator of the work vehicle 101 from within the cabin 102. For example, a display screen, such as a touch screen, may be mounted within the cabin 102, within view of an operator console, such that an operator may quickly and efficiently surveil the implement 104 during regular operation of the working vehicle 101. As an alternative to a display screen installed within the cabin 102 of the work vehicle 101, the display screen may form part of any other suitable device. For instance, the display screen may form part of a portable electronic device, such as a smart phone or tablet, that is carried by or otherwise accessible to the operator. In such instance, the interface 500 may be displayed on the portable electronic device.

Generally, the performance metrics view 522 may include performance metrics arranged on a pane or interface portion 520, and may display metrics gathered from sensors or devices on one or both of the vehicle 101 and the implement 104. The metrics may include speed, depth, downward pressure, downward force, or any suitable performance metrics. If displayed on a touch screen interface, the portion 520 may provide for an increase or decrease in size of the metrics view 522 based on input received from the touch-screen display. The input may include gestures, voice commands, or face recognition. Other manipulation may include at least scrolling up/down the list of metrics, increase/decrease in font size, or other manipulations

Similarly, the implement view 524 may be provided on a pane or interface portion 510, and may display a view similar to view 412 described above. Furthermore, if displayed on a touch screen interface, the portion 510 may provide for an increase or decrease in size of the virtualized 3D view 524 based on input received from the touch-screen display. The input may include gestures, voice commands, or face recognition. Other manipulation may include at least partial rotation of the view, as described above, or other manipulations.

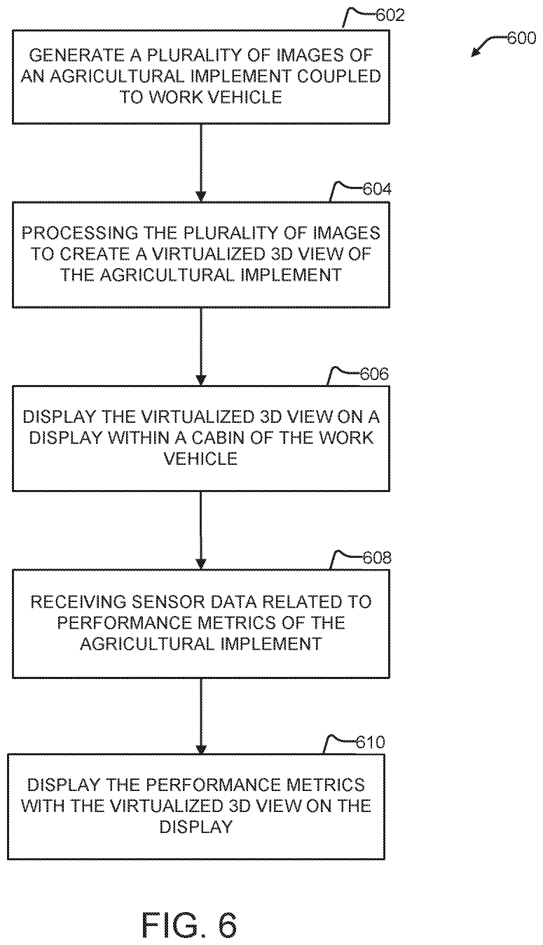

The virtualized 3D view may be generated based on any suitable algorithm, including computer-aided design algorithms configured to generate axonometric views of objects surveilled from at least two different perspectives with at least partially overlapping fields of view. Thus, relatively undistorted views of equipment, objects, and implements may be displayed as shown in the interface 500, for use by an operator. Hereinafter, the operation of the imaging system 120 and image processors 126 are described with reference to FIG. 6.

FIG. 6 illustrates a flowchart of a method 600 of surveilling agricultural machines, such as the agricultural machine 100 of FIG. 1 and FIG. 2, in accordance with aspects of the present subject matter. The method 600 includes generating a plurality of images of an agricultural implement 104 coupled to a work vehicle 101, at block 602. For example, the plurality of images can be taken from at least two perspectives of the agricultural implement 104, as illustrated in FIG. 2 and FIG. 4A. Generally, the plurality of images may be generated by at least two imaging devices, such as cameras 122′ and 122″. The imaging devices may be fixed or moveable.

The method 600 further includes processing the plurality of images to create a virtualized 3D view of the agricultural implement, at block 604. For example, the image processor 126 may process the images based on preconfigured algorithms configured to generate axonometric views, wireframe plots, or other views automatically. The preconfigured algorithms may include readily available computer aided design algorithms configured to generate axonometric views of objects surveilled from at least two different perspectives with at least partially overlapping fields of view.

The method 600 further includes displaying the virtualized 3D view on a display within a cabin 102 of the work vehicle 101, at block 606. For example, the virtualized 3D view may be provided on a graphical user interface, such as the interface 500.

The method 600 can also include receiving sensor data related to performance metrics of the agricultural implement 104, at block 608. The metrics gathered from the sensors or devices may be received from on one or both of the vehicle 101 and the implement 104. The metrics may include speed, depth, downward pressure, downward force, or any suitable performance metrics.

The method 600 can also include displaying the performance metrics with the virtualized 3D view, at block 610. For example, a performance metric view 522 can be provided through the graphical user interface 500.

As described above, a plurality of systems and methods for surveilling agricultural machines have been described. The systems and methods may be facilitated through two or more imaging devices, an image processor, and a display system. The image processor may include one or more processors or a computer apparatus configured to process images to create virtualized 3D views. The computer apparatus may be a general or specialized computer apparatus configured to perform various functions related to image or video manipulation and processing.

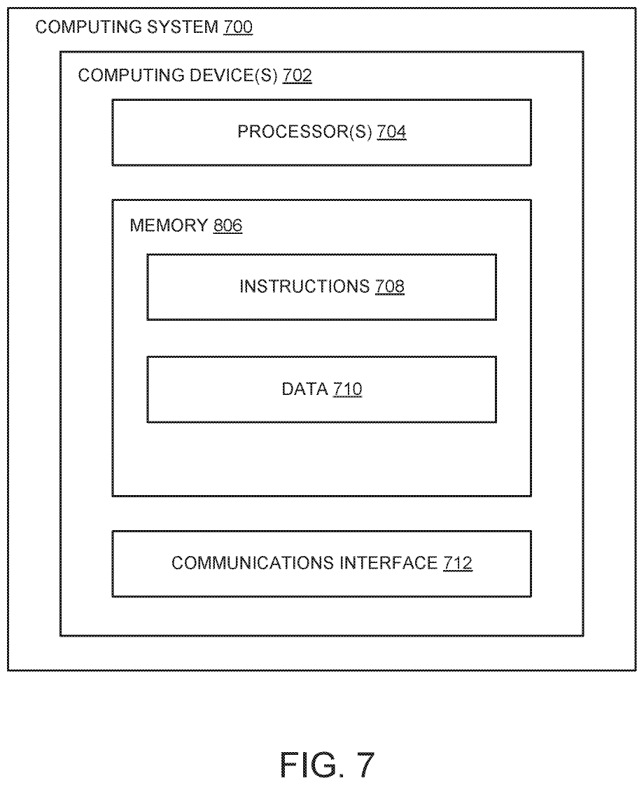

For example, FIG. 7 depicts a block diagram of an example computing system 700 that can be used to implement one or more components of the systems according to example embodiments of the present disclosure. As shown, the computing system 700 can include one or more computing device(s) 702. The one or more computing device(s) 702 can include one or more processor(s) 704 and one or more memory device(s) 706. The one or more processor(s) 704 can include any suitable processing device, such as a microprocessor, microcontroller, integrated circuit, logic device, or other suitable processing device. The one or more memory device(s) 706 can include one or more computer-readable media, including, but not limited to, non-transitory computer-readable media, RAM, ROM, hard drives, flash drives, or other memory devices.

The one or more memory device(s) 706 can store information accessible by the one or more processor(s) 704, including computer-readable instructions 708 that can be executed by the one or more processor(s) 704. The instructions 708 can be any set of instructions that when executed by the one or more processor(s) 704, cause the one or more processor(s) 704 to perform operations. The instructions 708 can be software written in any suitable programming language or can be implemented in hardware. In some embodiments, the instructions 708 can be executed by the one or more processor(s) 704 to cause the one or more processor(s) 704 to perform operations, such as the operations for surveilling agricultural machines, as described with reference to FIG. 6.

The memory device(s) 706 can further store data 710 that can be accessed by the processors 704. For example, the data 710 can include prior tool adjustment data, current tool adjustment data, wireframe examples of virtualized 3D views, instructions for generating virtualized 3D views from two or more images or video feeds, user interface wireframes or graphical data, and other suitable data, as described herein. The data 710 can include one or more table(s), function(s), algorithm(s), model(s), equation(s), etc. for presenting virtualized 3D views according to example embodiments of the present disclosure.

The one or more computing device(s) 702 can also include a communication interface 712 used to communicate, for example, with the other components of the system and/or other computing devices. The communication interface 712 can include any suitable components for interfacing with one or more network(s), including for example, transmitters, receivers, ports, controllers, antennas, or other suitable components.

It is also to be understood that the steps of the method 600 is performed by the controller 126 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the controller 126 described herein, such as the method 600, is implemented in software code or instructions which are tangibly stored on a tangible computer readable medium. The controller 126 loads the software code or instructions via a direct interface with the computer readable medium or via a wired and/or wireless network. Upon loading and executing such software code or instructions by the controller 126, the controller 126 may perform any of the functionality of the controller 126 described herein, including any steps of the method 600 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Although specific features of various embodiments may be shown in some drawings and not in others, this is for convenience only. In accordance with the principles of the present disclosure, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. An agricultural machine, comprising:
a work vehicle having a cabin; and
an agricultural implement configured to be towed behind the work vehicle to allow an agricultural operation to be performed within a field during which a tool of the agricultural implement engages ground within the field;
an imaging system proximate the work vehicle, the imaging system comprising a first imaging device having a first field of view directed towards the agricultural implement to allow a first plurality of images of the agricultural implement to be generated from a first perspective and a second imaging device having a second field of view directed towards the agricultural implement to allow a second plurality of images of the agricultural implement to be generated from a second perspective, the second perspective differing from the first perspective, the first and second pluralities of images being generated as the agricultural operation is being performed within the field;
one or more processors configured to process the first and second pluralities of images to create a virtualized 3D view of at least a portion of the agricultural implement as the agricultural operation is being performed within the field; and
a display system within the cabin, the display system configured to display the virtualized 3D view of the agricultural implement.

2. The agricultural machine of claim 1, wherein the first and second fields of view comprise at least partially overlapping fields of view.

3. The agricultural machine of claim 1, wherein the first and second imaging devices comprise first and second cameras affixed to different external surfaces of the work vehicle.

4. The agricultural machine of claim 1, wherein the first and second pluralities of images include video feeds of the agricultural implement; and,
wherein the virtualized 3D view is a virtualized 3D video of the at least a portion of the agricultural implement during operation.

5. The agricultural machine of claim 1, further comprising at least one sensor proximate the agricultural implement, the at least one sensor configured to detect one or more performance metrics of the agricultural implement.

6. The agricultural machine of claim 5, wherein the display system is further configured to display the one or more performance metrics with the virtualized 3D view of the agricultural implement.

7. The agricultural machine of claim 6, wherein the display system comprises a touch-screen display, and wherein the display system is further configured to display a graphical user interface configured to allow an increase or decrease in size of the virtualized 3D view based on input received from the touch-screen display.

8. A method of surveilling an agricultural machine, the agricultural machine comprising a work vehicle having a cabin, the agricultural machine further comprising an agricultural implement configured to be towed behind the work vehicle to allow an agricultural operation to be performed within a field during which a tool of the agricultural implement engages ground within the field, the method comprising:
generating a first plurality of images of the agricultural implement from a first perspective as the agricultural implement is being towed behind the work vehicle to perform the agricultural operation;
generating a second plurality of images of the agricultural implement from a second perspective as the agricultural implement is being towed behind the work vehicle to perform the agricultural operation, the second perspective differing from the first perspective;
processing the first and second pluralities of images to create a virtualized 3D view of at least a portion of the agricultural implement as the agricultural operation is being performed within the field; and
displaying the virtualized 3D view on a display within the cabin of the work vehicle.

9. The method of claim 8, wherein the first and second pluralities of images include video feeds of the agricultural implement; and,
wherein the virtualized 3D view is a virtualized 3D video of the at least a portion of the agricultural implement during operation.

10. The method of claim 9, further comprising:
receiving sensor data related to performance metrics of the agricultural implement; and
displaying the performance metrics with the virtualized 3D view.

11. The method of claim 10, further comprising:
generating and displaying a graphical user interface, the graphical user interface comprising a first display area for the virtualized 3D video and a second display area for the performance metrics.

12. The method of claim 11, further comprising:
receiving one or more touch-screen gestures in the first display area; and
altering a size, position, or perspective of the virtualized 3D video responsive to the one or more touch-screen gestures, voice commands, or facial recognition.

13. The method of claim 11, further comprising:
receiving one or more touch-screen gestures in the second display area; and
altering the display of the performance metrics responsive to the one or more touch-screen gestures.

14. The method of claim 8, further wherein processing the first and second pluralities of images to create the virtualized 3D view of the at least a portion of the agricultural implement comprises:
creating an axonometric view from the first and second pluralities of images, the axonometric view comprising a portion of a field of view of both of the first and second perspectives.

15. A system for surveilling an agricultural machine, the agricultural machine comprising a work vehicle having a cabin, the agricultural machine further comprising an agricultural implement configured to be towed behind the work vehicle to allow an agricultural operation to be performed within a field during which a tool of the agricultural implement engages ground within the field, the system comprising:
a first imaging device configured to be arranged proximate work vehicle, the first imaging device having a first field of view directed towards the agricultural implement to allow a first plurality of images of the agricultural implement to be generated from a first perspective as the agricultural operation is being performed within the field;
a second imaging device having a second field of view directed towards the agricultural implement to allow a second plurality of images of the agricultural implement to be generated from a second perspective as the agricultural operation is being performed within the field, the second perspective differing from the first perspective;
one or more processors configured to process the first and second pluralities of images to create a virtualized 3D view of at least a portion of the agricultural implement as the agricultural operation is being performed within the field; and
a display system configured to be mounted within the cabin, the display system configured to display the virtualized 3D view of the agricultural implement.

16. The system of claim 15, wherein the first and second fields of view comprise at least partially overlapping fields of view.

17. The system of claim 15, wherein first and second imaging devices comprise first and second cameras affixed to different external surfaces of the work vehicle.

18. The system of claim 15, wherein the first and second pluralities of images include video feeds of the agricultural implement; and,
wherein the virtualized 3D view is a virtualized 3D video of the at least a portion of the agricultural implement during operation.

19. The system of claim 15, further comprising at least one sensor proximate the agricultural implement, the at least one sensor configured to detect one or more performance metrics of the agricultural implement, and, wherein the display system is further configured to display the one or more performance metrics with the virtualized 3D view of the agricultural implement.

20. The system of claim 19, wherein the display system comprises a touch-screen display, and wherein the display system is further configured to display a graphical user interface configured to allow an increase or decrease in size of the virtualized 3D view based on input received from the touch-screen display.
